(19) United States
(12) Patent Application Publication
(10) Pub. No.: US 2008/0235950 A1
(43) Pub. Date: Oct. 2, 2008

(54) CONDENSING TUBE WITH CORRUGATED FINS

(75) Inventors: Petur Thors, Decatur, AL (US); Tommy Tyler, Hartselle, AL (US); Gary Eagleston, Decatur, AL (US)

Correspondence Address: BRADLEY ARANT ROSE & WHITE LLP, 200 CLINTON AVE. WEST, SUITE 900, HUNTSVILLE, AL, 35801, US

(73) Assignee: Wolverine Tube, Inc., Huntsville, AL (US)

(21) Appl. No.: 12/039,920

(22) Filed: Feb. 29, 2008

Related U.S. Application Data
(60) Provisional application No. 60/920,958, filed on Mar. 30, 2007.

(51) Int. Cl. B23P 15/26; F28F 1/36

(52) U.S. Cl. 29/890.046; 165/184

(57) ABSTRACT

The current invention includes a tube with a helical fin extending from the tube's outer surface. The fins and tube are monolithic, or formed of one part. The fin is continuous and the fin base is essentially straight as it winds around the tube. The fin has a tip opposite the fin base with an essentially straight fin body as viewed between the tip and the base. The fin is bent into concave and convex shapes about the tube wall so the fin tip makes a wavy pattern as it winds around the tube.

This patent application claims the benefit of U.S. Provisional Patent Application No. 60/920,958 filed Mar. 29, 2007.

### BACKGROUND OF THE INVENTION

A. Field of the Invention

This invention relates to finned tubes, especially as such tubes are used for heat transfer.

B. Description of the Related Art

Finned tubes have been used for some time and are frequently used for their heat transfer properties. Fins on a tube increase the overall surface area of the tube and the increased surface area serves to increase the rate at which heat can be transferred through the tube. Condensing tubes frequently have liquid flowing inside the tube with vapor on the outside of the tube. As the vapor cools and condenses into a liquid on the outside of the tube, heat is transferred to the inner liquid through the tube wall. It is generally desired to maximize the rate of heat transfer through the condensing tube.

Finned tubes have been in existence for some time. There are examples in the prior art of finned tubes where the fins on the tube exterior are bent and actually touch the neighboring fin. This produces a channel or pathway between the fin and the tube wall and is frequently used for boiling a liquid. Often these fins are bent at a position in the middle portion of the fin, somewhere between the fin base and the fin tip.

Other fins are bent in the middle portion of the fin to form corrugations. These corrugations produce alternating concave and convex shapes on the top portion of the fin while the bottom portion of the fin remains essentially flat. In some examples, the fin would only be corrugated on two sides of the tube with the fin on the remaining two sides of the tube being essentially flat or smooth from the top to the bottom.

Other tubes have corrugations in the fins with baffle-like structures interrupting or blocking the channels between fins. Some fin tubes have breaks in the fin so liquid flowing in a channel between two fins could flow through the break into a neighboring channel. There are also tubes with zigzag fins where the zigzag pattern of the fin extends all the way to the base of the fin. Such tubes can emphasize fin use for increased structural strength with less consideration given to heat transfer.

Although there are many varieties of finned tubes, further improvements are still sought. Any improvement which increases heat transfer rates is valuable. Therefore, it is an object of the current invention to produce a finned tube with improved heat transfer rates. It is a further objective to produce a finned tube with improved condensate shedding ability. Yet another objective is to produce a finned tube with a taller corrugated fin such that the fin has a larger surface. The above and other objects, features and advantages of the invention will become more apparent from the following description when read in conjunction with the accompanying drawings.

### BRIEF SUMMARY OF THE INVENTION

The current invention includes a tube with a helical fin extending from the tube's outer surface. The fin and tube are formed of one part so the fin is monolithic with the tube. A base of the helical fin remains essentially straight as it winds around the tube and the fin is continuous for at least one revolution around the tube. The fin has a body between the fin base and a fin tip. A fin angle phi φ is defined as the angle between the line perpendicular to a tube axis passing through the fin base and the line defined by the fin body. The fin angle varies along the length of the fin so that a fin sidewall forms alternating convex and concave shapes. The fin sidewall shapes have a wave length or a pitch which can be at least twenty times as long as a width of the fin tip.

### BRIEF DESCRIPTION OF DRAWINGS

FIG. 1 is a side view a portion of a finned tube with condensate between the fins.

FIG. 2 is a cross section of a heat exchanger.

FIG. 3 is a perspective view of a portion of a finned tube, with vertical fins.

FIG. 4 is a side view of a tube finning machine cutter forming a finned tube.

FIG. 5 is a perspective view of a portion of a finned tube, with bent fins.

FIG. 6 is a perspective view of a finned tube with bent fins and condensate.

FIG. 7 is a side view of a finned tube with a fin disk simultaneously bending two fins on the finned tube.

FIG. 8 is a side view of a finned tube with a fin disk bending one fin on the finned tube.

FIGS. 9a-9f are side views of various fin patterns on a finned tube.

FIG. 10 is a perspective view of a finned tube with bent fins

FIG. 11 is an end view of a finned tube.

FIG. 12 is a perspective view of two tube sheets with a finned tube positioned between them.

FIG. 13 is a graph showing the performance of the current invention compared to the prior art.

FIG. 14 is a graph showing the performance of the current invention compared to the prior art for the refrigerant R134a.

FIG. 15 is a graph showing the performance of the current invention compared to the prior art for the refrigerant R22.

FIG. 16 is a graph showing the performance of the current invention compared to the prior art for the refrigerant R123.

It should be noted that identical features in different drawings are shown with the same reference numeral.

### DETAILED DESCRIPTION

### Heat Transfer Fundamentals

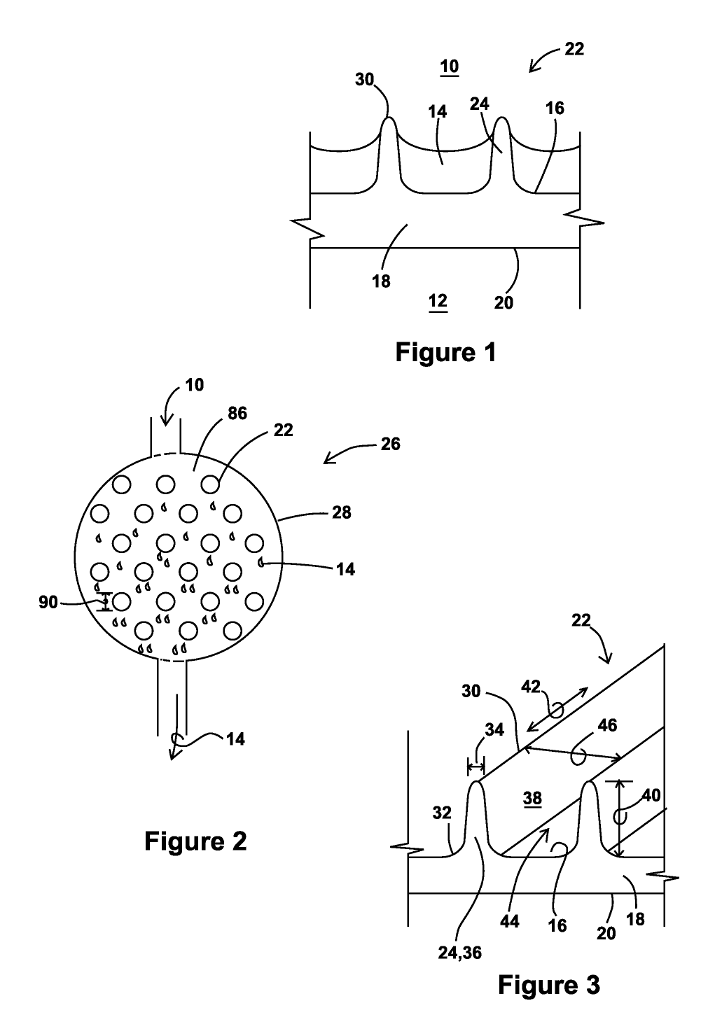

When a vapor 10 is condensed on a tube 22, heat is transferred from the vapor 10 to a cooling liquid 12 which generally flows inside the tube 22, as shown in FIG. 1. So vapor 10 is on the outside of the tube 22 and cooling liquid 12 is on the inside of the tube 22, and for the vapor 10 to condense, it has to transfer heat to the cooling liquid 12.

This transfer of heat goes through several steps. As the vapor 10 condenses, it forms condensate 14 which collects on an outer surface 16 of the tube 22. First, the vapor 10 transfers heat to the condensate 14 on the outer surface of the tube 16. Second, this heat flows through the condensate to the tube outer surface 16. Third, heat is transferred from the condensate 14 to the tube outer surface 16. Fourth, heat flows through the tube wall 18 from the outer surface 16 to the tube inner surface 20. Fifth, heat is transferred from the tube inner surface 20 to the cooling liquid 12. Finally, heat is transferred within the cooling liquid 12. Any interface between two separate materials provides some resistance to heat flow, and the utilization of heat conductors instead of heat insulators also improves heat flow. Heat flow can be improved by increasing the difference in temperature across a material or an interface, because temperature difference serves as power to drive heat flow.

This heat transfer process can be improved by minimizing or eliminating the condensate layer 14 on the tube outer surface 16, because the condensate 14 serves as a heat insulator. The tube wall 18 usually is produced from a material which readily conducts heat, or a heat conductor, so there is little resistance to heat flow through the tube wall 18. The cooling liquid 12 is generally flowing through the tube 22, so the heat transferred to the cooling liquid is carried away from the heat transfer area. Therefore, to maximize the rate of heat transfer, it is desirable to minimize or eliminate the condensate 14 on the tube outer surface 16. However, as the heat transfer efficiency increases, more condensate 14 is condensed onto the tube 22. To reduce the condensate 14, it needs to be shed from the tube 22.

It is also desirable to maximize the surface area on the tube outer surface 16 because the larger the surface area, the more area available for the vapor 10 or condensate 14 to transfer heat to the tube wall 18. The use of fins 24 on the tube outer surface 16 serves to increase the surface area available for heat transfer. Surface area can be further increased by increasing the number of fins 24 on the tube 22, or by increasing the surface area on a fin 24.

Finned tubes 22 are frequently used in the construction of heat exchangers 26, as best seen in FIG. 2. If a heat exchanger 26 is used to condense vapor 10, it can be referred to as a condenser. In one type of condenser 26, vapor 10 to be condensed is on the outside of a tube 22, and cooling liquid is flowing inside the tube 22. Several tubes 22 are typically bundled together within a heat exchanger shell 28. Often the finned tubes 22 run horizontally within a heat exchanger shell 28. Typically, vapor 10 enters the heat exchanger 26 from the top and is condensed as it contacts the finned tubes 22 within the heat exchanger 26. The condensate 14 drips off of the finned tubes 22 and flows downward until it exits the bottom of the heat exchanger 26. The condensate 14 from the upper tubes 22 drips on to the lower tubes 22 and tends to create a relatively thick layer of condensate 14 on the lower finned tubes 22. This thick condensate layer 14 serves to insulate the lower finned tubes 22, which results in less heat transfer and a reduced rate of condensation in the heat exchanger 26. This is referred to as flooding of the lower finned tubes 22.

Referring again to FIG. 1, most condensate 14 has certain fluid properties which affect the way the condensate 14 interacts with the tube outer surface 16. Surface tension is a force which a liquid exerts at the liquid surface. Surface tension tends to cause the upper surface of a liquid to have either a convex or a concave shape, and the concave shape as shown is more common. This convex or concave shape is called a meniscus. In FIG. 1 the condensate 14 is shown with a concave meniscus wherein the liquid at the edge of the condensate 14 is attracted up the side of the fin 24. Because surface tension usually draws a liquid up the side of a container, it is found that most liquids tend to accumulate in concave structures and to be somewhat repelled from convex structures. In simplified terms, this means the liquid tends to pool in areas where the surface is cupped and it tends to be repelled from areas where the surface is bowed out. This is shown in FIG. 1 where the condensate 14 collects in the cup between the fins 24, but the condensate 14 is repelled from the convex surface which would be the fin tip 30.

Another fluid property is that liquids tend to run down hill. Gravity pulls on liquids and draws liquids down hill or toward the center of the earth. This gravitational force depends on the mass of the liquid present, so the gravitational force gets stronger as the weight of the liquid increases. Therefore, as a liquid congregates in a concave or cup-like shape that is on an angle, gravity will tend to pull the liquid out of this concave shape. So, the more liquid that gathers in the concave shape, the larger the mass of the liquid, and the stronger the tendency for gravity to pull the liquid out of the concave shape. Therefore, when the amount of liquid builds up sufficiently, the gravitational force overcomes the surface tension force and at least a portion of the liquid falls out of the concave or cup-like structure. This portion of liquid can fall out as a drop.

### Condensing Tubes with Corrugated Fins

Finned condensing tubes 22, including the fins 24, are usually made of a material which readily conducts heat. Often this material is metallic, and frequently copper is a main component. Often, the copper will be at concentrations of 80% or more in the metallic material from which the tube is made. However, it is possible to produce finned tubes 22 from other materials. Frequently the finned tubes 22 will be one-half inch to one inch in diameter.

Finned tubes 22 of the current invention include fins 24 extending from the tube outer surface 16, as shown in FIG. 3. Each fin 24 can be broken down into several different parts. The fin base 32 is at the bottom of the fin 24, and is the portion of the fin 24 which is connected to the tube outer surface 16. The fin tip 30 is at the top of the fin 24, and therefore is at the opposite end of the fin 24 as the fin base 32. The fin body 36 is the main part of the fin 24, and is the part of the fin 24 between the fin base 32 and the fin tip 30. The fin 24 has a fin side surface 38, which is the exterior surface or face between the fin base 32 and the fin tip 30. A typical fin 24 would have two fin side surfaces 38, with one on each side of the fin body 36. The fin tip 30 has a fin tip width 34, which is generally measured at the point where the side surfaces 38 begin to curve together for the fin tip 30.

The fin height 40 is measured from the fin base 32 to the fin tip 30. The fin 24 also has a length 42, which runs perpendicular to the fin height 40 and the tip width 34. Therefore, the fin length 42 runs parallel with the fin tip 30 and the fin base 32. A channel 44 exists between two adjacent fins 24. Fins 24 will frequently have a fin height 40 of between 0.02 to 0.05 inches and a fin tip width 34 of approximately 0.002 inches. The fins 24 will have a pitch 46 or wave length 46 which is measured from one fin tip 30 to an adjacent fin tip 30. The fin pitch 46 is determined by the number of fins 24 per inch. Frequently there will be somewhere between 16 to 60 fins per inch, which means that the pitch 46 will be 0.063 inches to 0.017 inches.

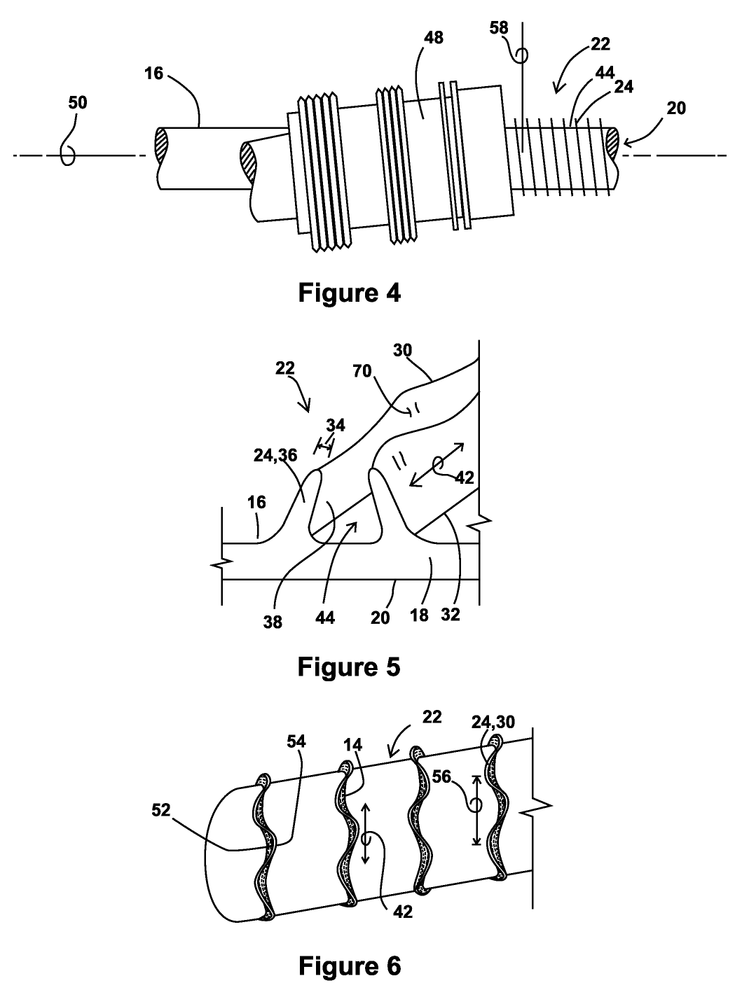

Often the fins 24 on a tube 22 are helical, as shown in FIG. 4. If the fin 24 is helical, it is possible for an entire tube to have one single fin 24 which wraps around and around the tube, similar to the threads on a screw or a bolt. If the finned tube 22 has a single fin 24, it is understood the channel 44 between two adjacent fins 24 is actually a channel 44 between two parts of a single fin on a separate pass around the tube 22. A finned tube 22 can have one, two, or more helical fins 24 formed on the outer surface 16, and the number of independent fins 24 is referred to as the number of fin starts.

Often the fins 24 will be formed on a finned tube 22 using a tube finning machine. A cutting head of a tube finning machine, also called an arbor, is depicted as item 48 in FIG. 4. Such tube finning machines are common in the industry and are well known to one skilled in the art. When a finning machine is creating fins 24 on a tube outer surface 16, ridges or other textures can be simultaneously formed on the inner surface 20 of the tube 22. The tube inner surface 20 can be smooth or textured, as desired, and almost any inner surface is consistent with the current invention.

A finned tube 22 will typically have an axis 50 which runs down the exact center of the finned tube 22. When a finning machine produces fins 24 on a tube 22, these fins are typically essentially parallel with a line 58 which runs perpendicular to the tube axis 50. The fins 24 are cut helically, so they are not quite parallel with the line 58 radiating from the axis 50, and the degree of this difference is dependant on the number fins 24 per inch, the tube diameter, and the number of fin starts.

The fins 24 are also monolithic with the tube wall 18, as seen in FIG. 1. This means the fins 24 are formed as a part of the tube wall 18. There is no interface between the fin 24 and the tube wall 18, so if some sort of fin material were adhered to a tube wall 18, that fin material would not be monolithic with the tube wall 18. This is important because any interface tends to resist heat flow. If the fin 24 is monolithic with the tube wall 18, there is less resistance to heat flow from the fin 24 to the tube inner surface 20 and this results in a superior heat transfer product.

It is possible for the fins 24 on a tube 22 to be bent, as shown in FIGS. 5 and 6. When the fins 24 are bent, they form alternating concave shapes 52 and convex shapes 54 in the fin side surface 38. Of course, a concave shape 52 on one fin side surface 38 also forms a convex shape 54 on the opposite fin side surface 38 of the same fin 24. These concave and convex shapes 52, 54 form the corrugations in the fin 24 of the current invention. These convex and concave shapes 52, 54 run along the fin length 42 and produce a corrugation wave length 56 or corrugation pitch 56, which is measured from the peak of two adjacent convex shapes 54 and/or the valleys of two adjacent concave shapes 52. This corrugation pitch 56 can be at least twenty times the tip width 34, which can produce a corrugation pitch 56 in the range of 0.02 to 0.17 inches or more. When the corrugation pitch 56 is at least twenty times the tip width 34, the fin corrugations are relatively gradual.

To form the corrugation pitch 56, the fins 24 are bent from the fin base 32. This means that the fins 24 are not bent from the middle, which would be a portion of the fin 24 between the fin base 32 and the fin tip 30. Therefore, the fin body 36 extends essentially straight as viewed between the fin base 32 and the fin tip 30. Referring now to FIGS. 3, 5 and 8, the fins 24 can be bent to an angle measured from the line 58 passing perpendicular to the tube axis 50 through fin base 32 and a line defined by the fin body 60. This produces the fin angle 62, which is referred to as phi (φ). The fin angle phi φ 62 varies along the length 42 of the fin 24, and typically varies between vertical, or 0 degrees, and at least 15 degrees. Phi φ 62 can be up to 35 degrees or more. The fins 24 can all be bent in one direction, in which case φ 62 is always either positive or negative, or the fins 24 can be bent both directions, in which case φ 62 would be both positive and negative and could vary between at least +/−15 degrees. Preferably phi φ 62 varies between approximately +/−25 degrees.

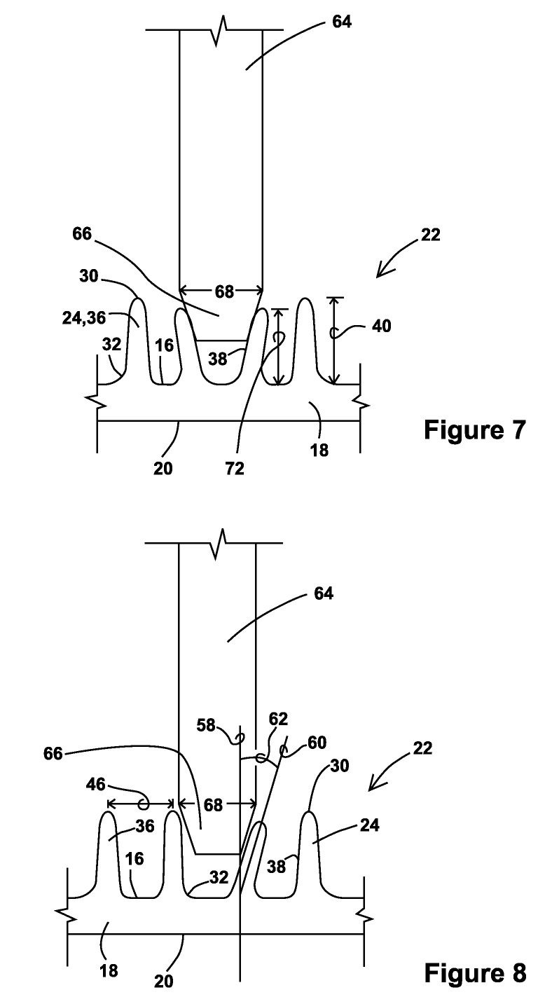

Typically the fins 24 are bent after being formed by the tube finning machine. These fins 24 can be bent by a fin disk 64, as shown in FIGS. 7 and 8. The fin disk 64 has fin disk teeth 66, which contact a fin side surface 38 and bend the fin 24 at the fin base 32. The fin disk teeth 66 can have a tooth width 68 which is initially smaller than the fin pitch 46, but widens towards the base of the fin disk tooth 66 such that the base of the fin disk tooth 66 has a width 68 which is greater than the fin pitch 46. In this case, the fin disk tooth 66 can contact facing fin side surfaces 38 and bend those adjacent fins 24 away from each other as shown in FIG. 7. Alternatively, the fin disk tooth can be forced to contact a single fin side surface 38 and bend a single fin 24, as depicted in FIG. 8.

The fin disk tooth 66 can form marks 70 or scratches 70 on the fin side surface 38, as shown in FIGS. 5, 7 and 8. When a fin 24 is bent, the fin base 32 remains essentially straight as the fin base 32 winds helically around then fin tube 22. The fin tip 30, however, becomes wavy as the fins 24 are bent.

A fin elevation 72 is defined as the distance between the fin tip 30 and the tube outer surface 16. In this discussion, the tube outer surface 16 is the portion of the tube at the fin base 32, so a fin root diameter of the tube 22 would be measured from the fin base 32 or the tube outer surface 16. Before a fin 24 is bent, the fin elevation 72 is the same as the fin height 40 because the fin 24 is essentially perpendicular to the fin outer surface 16. However, after the fin 24 is bent, the fin elevation of 72 is less than the fin height 40. The fin elevation 72 can be determined by multiplying the fin height 40 by the cosine of the fin angle φ 62. Because the fin angle 62 can be zero, the fin elevation 72 is less than or equal to the fin height 40.

After fins 24 are bent, the fin elevation 72 is less than the fin height 40. This serves to reduce the nominal outside diameter of the finned tube 22, where the nominal outside diameter is measured from the fin tips 30. Unspecific references to the outside diameter generally refer to the nominal outside diameter, as opposed to the fin root diameter. Referring now to FIGS. 2, 7, and 12, finned tubes 22 can be installed in heat exchangers 26. These finned tubes 22 are typically inserted through a tube sheet 86 to form the heat exchanger 26, and the tube sheet 86 connects with the heat exchanger shell 28. The tube sheet 86 has holes 88 of a pre-determined size, so a nominal outside diameter 90 of a finned tube 22 has to be less than or equal to this pre-determined size. Because the fin elevation 72 is less than the fin height 40, it is possible to use a larger fin height 40 when constructing a heat exchanger using a tube sheet 86 with holes 88 of a set size. Because a larger fin height 40 can be used, it is possible to produce more surface area on the finned tube 22. This is because a larger fin height 40 results in more surface area if all other factors are held constant. This larger surface area can result in a higher rate of heat transfer. The bending of the fins 24 also tends to stretch the fins 24 slightly, which also marginally increases surface area.

Referring to FIGS. 6, 7 and 8, when the fin disk 64 bends the fins 24, many different shapes of corrugated fin 24 are possible. These different shapes of corrugated fin 24 are obtained by bending the fin 24 at discrete locations so that one portion of the fin 24 will be bent and an adjacent portion will not be bent. It is also possible to bend the fin 24 in opposite directions so one portion of the fin 24 will be bent one way and an adjacent portion will be bent the opposite direction. By using different fin disk 64 shapes and different patterns of fin disk 64 operations, various patterns of corrugated fin 24 can be produced on the finned tube 22.

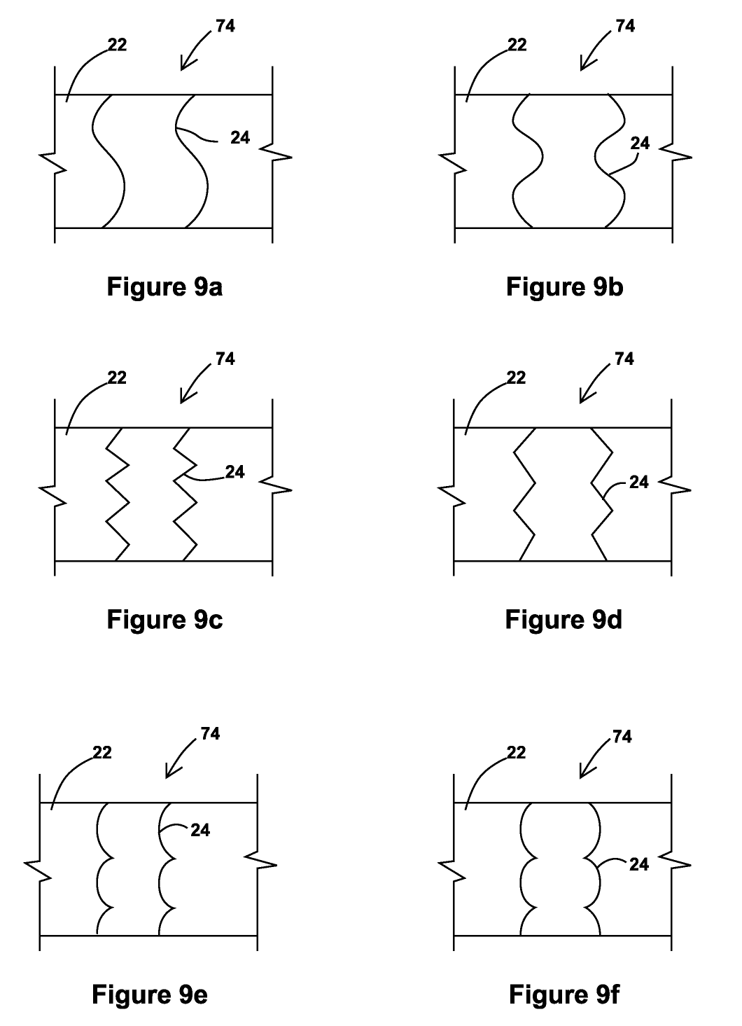

FIGS. 9a, 9b, 9c, 9d, 9e, and 9f show various patterns 74 that are possible for the corrugated fin 24. The fin pattern 74 can be corresponding, as shown in FIGS. 9a, 9c, and 9e, where adjacent fins 24 are bent the same direction. The fin pattern 74 can also be opposed, as shown in FIGS. 9b, 9d, and 9f, where adjacent fins 24 are bent opposite directions. The pattern 74 can have smooth shapes or curves as shown in FIGS. 9a and 9b, or more jagged shapes as shown in FIGS. 9c and 9d. It is also possible for the pattern 74 to have a mixture of smooth and jagged shapes, as shown in FIGS. 9e and 9f. Regardless of whether the shapes are jagged or smooth, the shape is referred to as either convex or concave. It is even possible for the fin pattern 74 to be random, such that the corrugations in one fin 24 are unrelated to the corrugations in a neighboring fin 24.

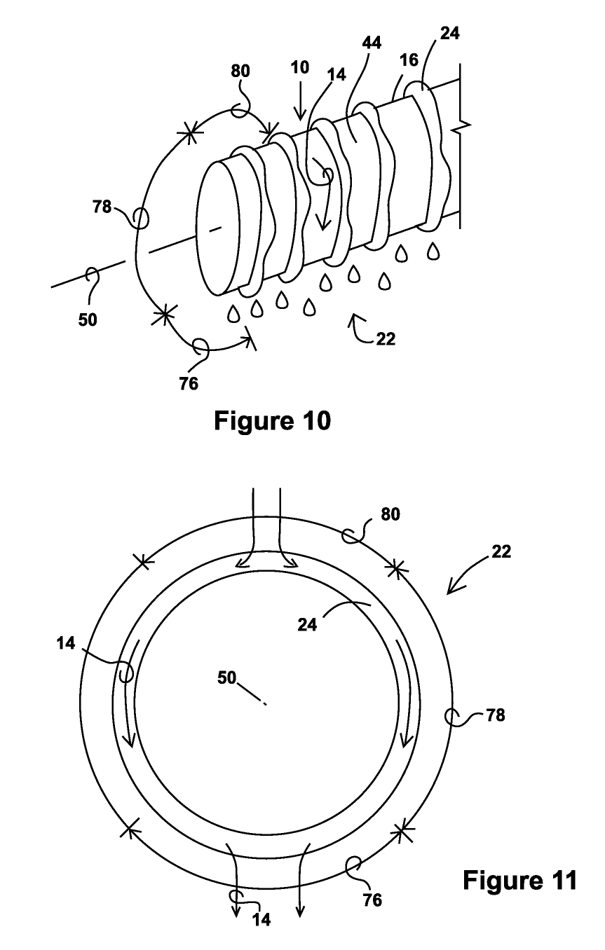

Referring to FIGS. 1, 5, 7, and 8 it is noted that the fins 24 are preferably freestanding, meaning that adjacent fins do not touch. Therefore, a fin tip 30 will only contact condensate 14 or vapor 10. Referring now to FIGS. 6 and 10, it is also preferable if the fin 24 is continuous for at least one revolution around the tube 22, and preferably for the entire length of the fin 24. This means the fin 24 is not broken so any condensate 14 in a channel 44 would not be able to flow through a gap into an adjacent channel 44. It also means there are no baffles running across the fin 24. A baffle would be some sort of obstruction that would cross a fin 24 and cause condensate 14 flowing through a channel 44 to run into the baffle. The condensate 14 would then have to pass over the baffle to continue flowing in the channel 44.

### Corrugated Fin Performance

One significant advantage of the current invention is the corrugated fins 24 allow for the fin tube 22 to shed condensate 14 much more quickly. Referring now to FIGS. 6, 10 and 11, a finned tube 22 can be divided into three regions to better understand how the tube 22 sheds condensate 14. The first region is the bottom region 76. Condensate that runs to the bottom region 76 tends to gather in the concave shapes 52. As the condensate 14 gathers, the mass of condensate 14 increases to the point where gravity overcomes the surface tension of the condensate 14, and drops of liquid fall off the tube 22. Because of the concave shapes 52, the liquid pools in smaller areas than if the fins 24 were not bent. This pooling of the liquid causes the drops to form more quickly than on a finned tube 22 without corrugated fins 24. This is because more condensate mass is concentrated in a smaller area, thus allowing the gravitational force to overcome the surface tension force and form a drop.

The next region of the tube is the side region 78. In the side region 78, gravity pulls the condensate 14 downwards along the side of the tube 22. Any resistance to flow should be minimized so the flow rate of the condensate 14 is maximized. Because of this, the convolutions and the corrugations in the fin 24 should be more gradual because sharper corrugations result in more resistance to flow. The ratio of the corrugation pitch 56 being at least 20 times the fin tip width 34 produces a more gradual corrugation. This produces less resistance to flow and a faster condensate flow rate down this side region 78 of the tube 22.

The final region of the tube 22 is the top region 80. In the top region 80, condensate 14 tends to gather in the concave shapes 52 and the condensate 14 tends to avoid the convex shapes 54. The surface of the convex shapes 54 is therefore relatively free of condensate 14. Without the insulating effects of condensate 14, these convex shaped 54 areas produce a higher rate of heat transfer. This produces more condensate 14, which flows into and eventually overflows the concave shaped area 52, so a drop of condensate begins to flow downhill. Because surface tension causes the drop to avoid convex shapes 54, the drop tends to quickly slip by these areas. Surface tension also tends to draw liquids together, like beads of water on a waxed car. As this drop of condensate 14 flows past other concave shapes 52 with condensate drops, the drops merge by surface tension. This increases the mass of the drop, and therefore increases the gravitational force urging the drop downhill. After the large drop has pulled the condensate 14 from a concave shape 52, the fin side surface 38 in the concave area 52 is relatively free of condensate 14, which increases the rate of heat transfer and the rate of condensation. This produces more condensate 14, which feeds the process of moving the condensate 14 downhill.

As mentioned previously, the process of bending the fins can cause notches or scratches 70 in the fin side surface, as seen in FIGS. 5 and 10. These notches tend to form more surface area, because the smooth side surface is interrupted by the scratch 70. In effect, this makes a small concave shape inside the primary concave shape 52 in the fin 24. Therefore, the scratches 70 tend to at least marginally improve the overall performance of the tube 22. These scratches 70 can be particularly helpful in drop formation in the tube bottom region 76 because they can serve as a nucleation site for the formation of drops.

Because the fin 24 is bent from the fin base 32, the total area within a concave shape 52 and a corresponding convex shape 54 is larger than if the fin 24 had been bent in the middle of the fin body 36, as shown in FIGS. 5, 6 and 7. This results in more area having the convex and concave shapes 52, 54 and improves the overall performance of the finned tube 22. The condensate shedding ability of the tube 22 is also improved by bending the fins 24 from the fin base 32, as opposed to bending the fins 24 in the middle of the fin body 36. The drops or pools of condensate 14 that form in the concave shapes 52 are able to begin forming with less condensate 14 because the fin 24 is bent from the base 32. This is because the concave shape 52 begins at the fin base 32. furthermore, the fin disk 64 bends the fin 22 at the base 32 simply by contacting the side surface 38. This allows for an easier production process in the manufacture of the finned tube 22.

The continuous nature of the fin 24, as seen in FIGS. 6 and 10, improves the performance of the finned tube 22. Helical fins 24 run around the tube 22 and therefore any condensate 14 that gathers on a horizontal tube 22 can flow downhill through the channels. If the fins 22 were not helical, but instead ran parallel with the tube axis 50, condensate 14 would have to flow over the fin tip 30 as it traveled down the tube 22. Flowing through the channels 44 provides far less flow resistance than flowing over fin tips 30. Therefore, the helical nature of the fins 22 improves the flow of condensate 14 and the condensate shedding aspect of the finned tube 22. The characteristic of the tube 22 to shed condensate improves heat transfer rates because of the reduction in the insulating effect of the condensate 14.

The lack of baffles also improves the performance of the tube 22, because any baffles crossing the fins 24 would serve as an impediment to the flow of condensate 14. Anything that impedes condensate flow hampers the condensate shedding ability of the tube 22. Therefore, the fins 22 are continuous for at least one complete revolution around the tube and preferably are continuous throughout the tube. The term continuous means the fins 22 are not interrupted by a gap going essentially to the fin base 32, and there are no baffles or barriers in the design which would cross a channel 44 from one fin side surface 38 to a facing fin side surface 38.

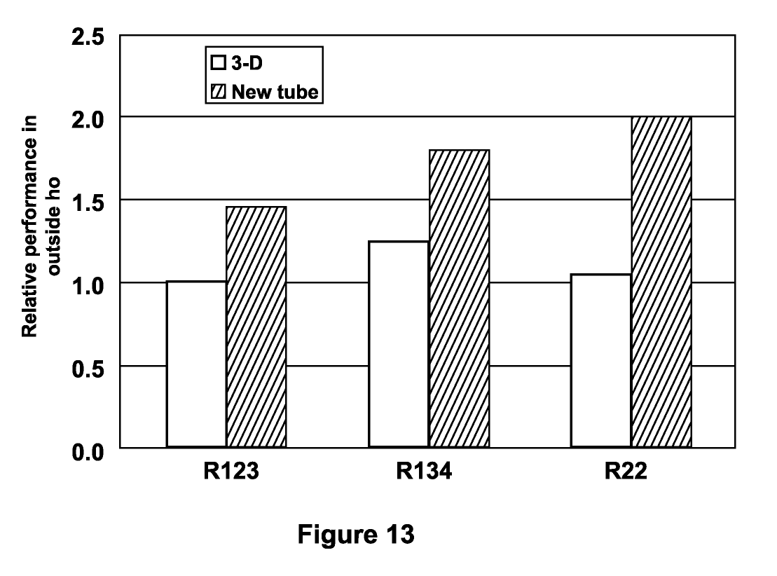

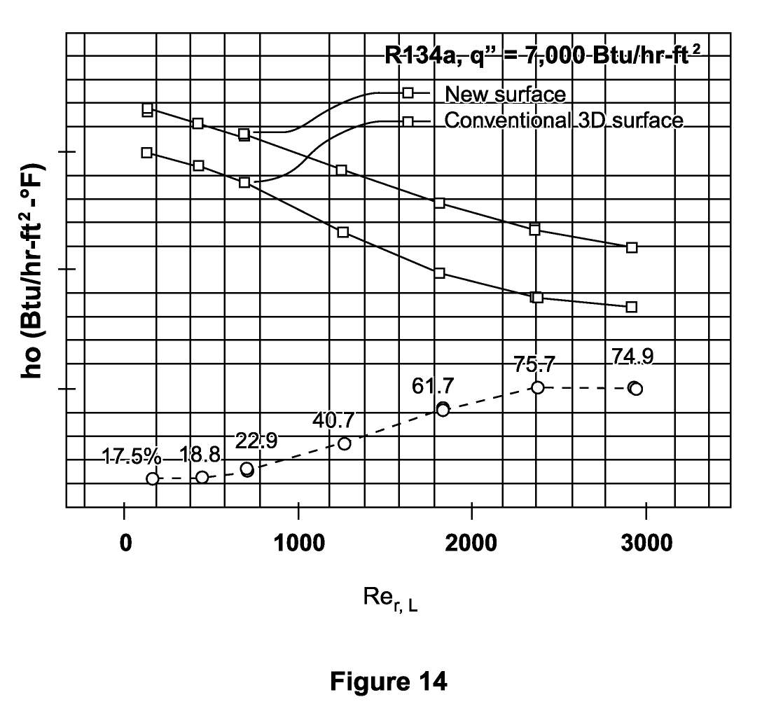

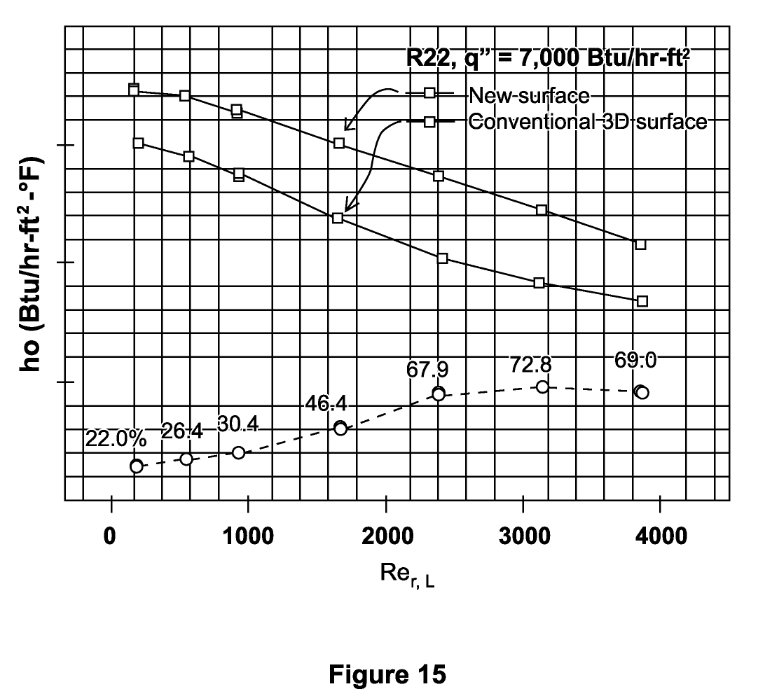

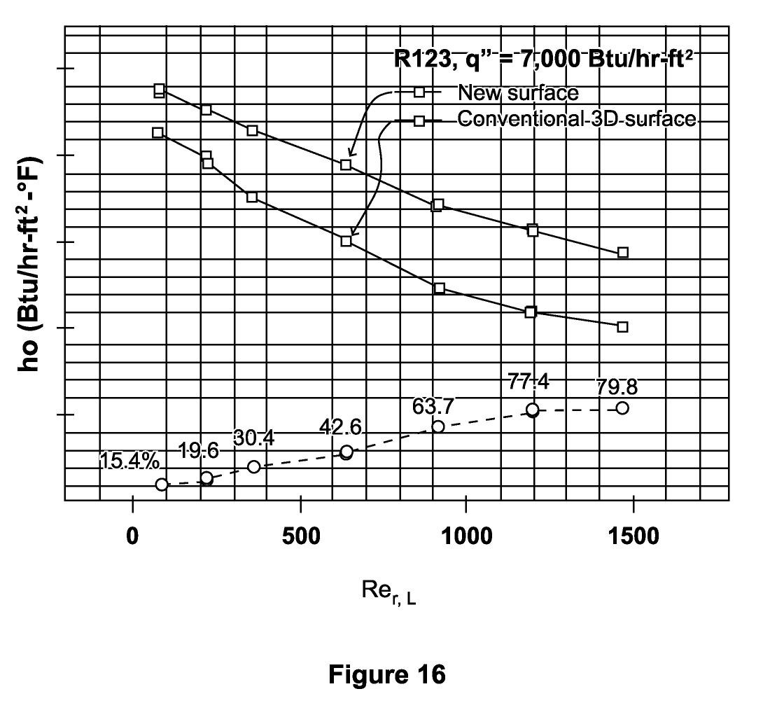

The results of the current invention do provide a significant advantage over the prior art. The graphs shown in FIGS. 13, 14, 15, and 16 show the performance of the tubes 22 of the current invention as compared to conventional finned tubes. In conventional finned tubes, the fins remain vertical and are not bent at the base as in the current invention. FIG. 13 shows the relative performance in the outside surface rate of heat transfer for three different coolants—R123, R134, and R22. The graph in FIG. 14 shows the relative performance of the tube of the current invention as compared to a conventional tube for the coolant R134a at various condensate liquid Reynolds numbers. The graphs in FIGS. 15 and 16 show similar results for R22 and R123, respectively.

As can be seen, the tube superiority of the current invention increases as the liquid condensate Reynolds numbers increase. The liquid condensate Reynolds number is increased primarily by an increased flow rate, and one characteristic of the current invention is the ability to more rapidly shed condensate. Therefore, the conventional tube becomes flooded more quickly, and has less surface area free of an insulating condensate layer than the tube of the current invention. Higher condensate flow rates increase the significance of this difference. The increased surface area of the bent fins accounts for part of the improved efficiency of the current invention, but the efficiency is improved by more than is attributable to the increased surface area. The ability to more rapidly shed condensate is a significant factor in the current invention's increased efficiency.

### Heat Exchanger Construction

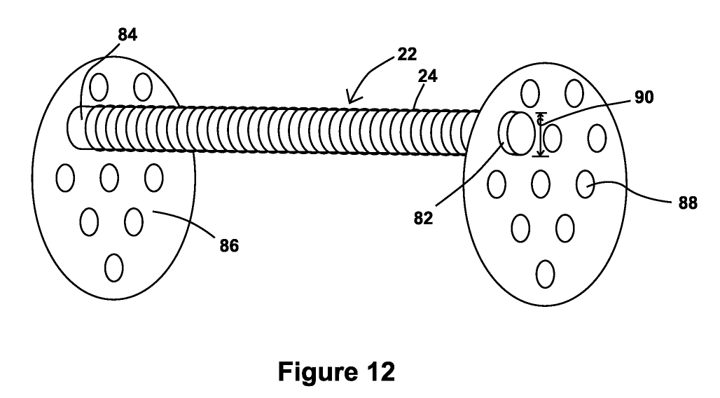

Shell and tube heat exchangers typically include tube sheets 86, which are inside a heat exchanger shell and attached to the ends of the heat exchanger tubes 22, as seen in FIGS. 2 and 12. The tube sheet 86 has holes 88 through which the tube 22 is inserted, and a seal is then made between the tube 22 and the tube sheet 86. To provide a good seal between the tube sheet 86 and the tube 22, it is desirable for the tube 22 to be relatively smooth where this seal is made. The tube 22 has a front end 82 and a back end 84, and there are no fins 22 on the front and back end 82, 84 so these smoother regions are available to provide a seal with the tube sheet 86 in the heat exchanger 26. Because of this, when the finned tubes 22 are produced for heat exchangers, it is desirable to begin the finning operation after a front end of the tube 82 and to terminate the finning process before a back end of the tube 84. Generally, the method of producing finned tubes for heat exchangers includes providing a tube, forming continuous, helical, essentially straight fins on the tube outer surface, and bending the fins to produce the fin pattern.

While the invention has been described with respect to a limited number of embodiments, those skilled in the art, having the benefit of this disclosure, will appreciate that other embodiments can be devised which do not depart from the scope of the invention as disclosed here. Accordingly, the scope of the invention should be limited only by the attached claims.

What is claimed is:

1. A finned tube comprising:
a tube having an outer surface and an axis;
a helical fin extending from the outer surface, the fin having an essentially straight base at the connection point to the tube, a tip opposite the base, a body extending essentially straight from the base to the tip, and a length, wherein the fin is monolithic with the tube and the fin is continuous for at least one revolution around the tube; and
a fin angle phi, wherein phi varies along the length of the fin.

2. The finned tube of claim 1 wherein the fin angle phi varies between at least 15 degrees and 0 degrees.

3. The finned tube of claim 2 wherein the fin angle phi varies between at least +15 degrees and −15 degrees.

4. The finned tube of claim 1 wherein the fin is bent to form alternating convex and concave shapes having a corrugation pitch, and the fin tip has a width, and the corrugation pitch is at least 20 times the fin tip width.

5. The finned tube of claim 1 wherein the fin is freestanding.

6. The finned tube of claim 1 further comprising a fin elevation measured from the fin tip to the tube surface, and a fin height measured from the fin base to the fin tip, and the fin elevation is less than or equal to the fin height.

7. The finned tube of claim 1 wherein the tube and fin are comprised of a metallic material.

8. The finned tube of claim 7 wherein the metallic material is at least 80 percent copper.

9. A finned tube comprising:
a tube having an outer surface and an axis;
a fin extending from the outer surface, the fin having a base at the connection point to the tube, a tip opposite the base, a body extending from the base to the tip, and a length, wherein the base is essentially straight, the tip has a width, the body includes a side surface, and wherein the fin is monolithic with the tube; and
alternating concave and convex shapes formed in the fin side surface along the length of the fin, wherein the shapes have a corrugation pitch at least twenty times the tip width.

10. The finned tube of claim 9 further comprising a fin angle phi, wherein phi varies between at least 15 degrees and 0 degrees.

11. The finned tube of claim 10 wherein phi varies between at least +15 degrees and −15 degrees.

12. The finned tube of claim 9 wherein the fin is freestanding.

13. The finned tube of claim 9 wherein the body is essentially straight between the base and the tip.

14. The finned tube of claim 9 wherein the tube and fin are comprised of a metallic material.

15. The finned tube of claim 14 wherein the metallic material is at least 80 percent copper.

16. A method of producing a finned tube comprising:
a) providing a tube,
b) forming a helical, continuous, essentially straight fin on an outer surface of the tube; and
c) bending the fin at a fin base such that a fin angle phi varies along a length of the fin.

17. The method of claim 16 wherein step c) further comprises bending the fin such that phi varies between +15 degrees and −15 degrees.

18. The method of claim 16 wherein step a) further comprises providing a tube comprising a metallic material.

19. The method of claim 16 wherein step b) further comprises initiating the fin formation after a front end of the tube, and terminating the fin formation before a back end of the tube, such that the tube has front and back ends without a fin.

20. The method of claim 16 further comprising installing the finned tube in a heat exchanger.
